(19) United States
(12) Patent Application Publication
(10) Pub. No.: US 2012/0102455 A1
(43) Pub. Date: Apr. 26, 2012

(54) SYSTEM AND APPARATUS FOR HOSTING APPLICATIONS ON A STORAGE ARRAY VIA AN APPLICATION INTEGRATION FRAMEWORK

(75) Inventors: Gopakumar Ambat, Bangalore (IN); Vishwanath Nagalingappa Hawargi, Bangalore (IN); Giribabu Balaraman, Bangalore (IN)

(73) Assignee: LSI Corporation, Milpitas, CA (US)

(21) Appl. No.: 12/912,227

(22) Filed: Oct. 26, 2010

(51) Int. Cl. G06F 9/44

(52) U.S. Cl. 717/115; 717/100

(57) ABSTRACT

A storage array is disclosed. The storage array may comprise a plurality of storage units configured for providing data storage; a processing module configured for hosting a virtual machine; and an application integration framework provided by the virtual machine. The application integration framework may comprise an application interface configured for interfacing with at least one application running on an application server, where the application server is communicatively connected with the storage array. The application integration framework may further comprise a software development kit (SDK) communicatively coupled to the application interface via a communication module, the SDK being configured for providing a programmatic interface to the at least one application and enabling the at least one application for delegating at least a portion of data processing operations to the storage array.

### TECHNICAL FIELD

The present invention relates to the field of storage systems and particularly to a system and method for hosting applications on a storage array.

### BACKGROUND

A storage array is a storage system which contains multiple storage units such as disk drives or the like. Various applications running on one or more application servers may access the data stored in a storage array via a storage network (e.g., SCSI, iSCSI, FC, SAS or the like). A typical storage array may provide the requested data to the application servers, and the respective applications may utilize the processing powers of the application servers to perform data processing and/or data rendering. Transferring data over the storage network may utilize a large portion of the available network bandwidth.

### SUMMARY

Accordingly, an embodiment of the present disclosure is directed to a storage array. The storage array may comprise a plurality of storage units configured for providing data storage; a processing module configured for hosting a virtual machine; and an application integration framework provided by the virtual machine. The application integration framework may comprise an application interface configured for interfacing with at least one application running on an application server, where the application server is communicatively connected with the storage array. The application integration framework may further comprise a software development kit (SDK) communicatively coupled to the application interface via a communication module, the SDK being configured for providing a programmatic interface to the at least one application and enabling the at least one application for delegating at least a portion of data processing operations to the storage array.

A further embodiment of the present disclosure is directed to an application integration framework provided by a virtual machine running on a storage array. The application integration framework may comprise an application interface configured for interfacing with at least one application running on an application server, where the application server is communicatively connected with the storage array. The application integration framework may further comprise a software development kit (SDK) communicatively coupled to the application interface via a communication module, the SDK being configured for providing a programmatic interface to the at least one application and enabling the at least one application for delegating at least a portion of data processing operations to the storage array.

An additional embodiment of the present disclosure is directed to a method. The method may comprise hosting a virtual machine on a storage array; providing an application interface, the application interface configured for interfacing with at least one application running on an application server, the application server communicatively connected with the storage array; and providing a software development kit (SDK), the SDK communicatively coupled to the application interface via a communication module, the SDK configured for providing a programmatic interface to the at least one application and enabling the at least one application for delegating at least a portion of data processing operations to the storage array; wherein the application interface, the SDK and the communication module are being provided by the virtual machine hosted on the storage array.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustrating a computing system utilizing the storage array in accordance with the present disclosure;

FIG. 2 is a block diagram illustrating an exemplary implementation of an application integration framework; and

FIG. 3 is a flow chart illustrating a method for enabling an application to delegate at least a portion of data processing operations to a storage array in accordance with the present disclosure.

### DETAILED DESCRIPTION

Reference will now be made in detail to the presently preferred embodiments of the invention, examples of which are illustrated in the accompanying drawings.

With the advent of new generation storage arrays, there is a greater scope of hosting applications on such storage arrays natively. A new generation storage array may have increased memory/processing power, and may be capable of hosting an operating system (e.g., on a virtual machine) on which programs/processes may be carried out. Therefore, instead of merely providing data to an application server via a storage network, it may be appreciated that the storage array itself may provide a framework for hosting/executing data handling functionalities (e.g., data processing, data rendering or the like) natively. The present disclosure is directed to a system, apparatus and method for hosting applications on a storage array via an application integration framework.

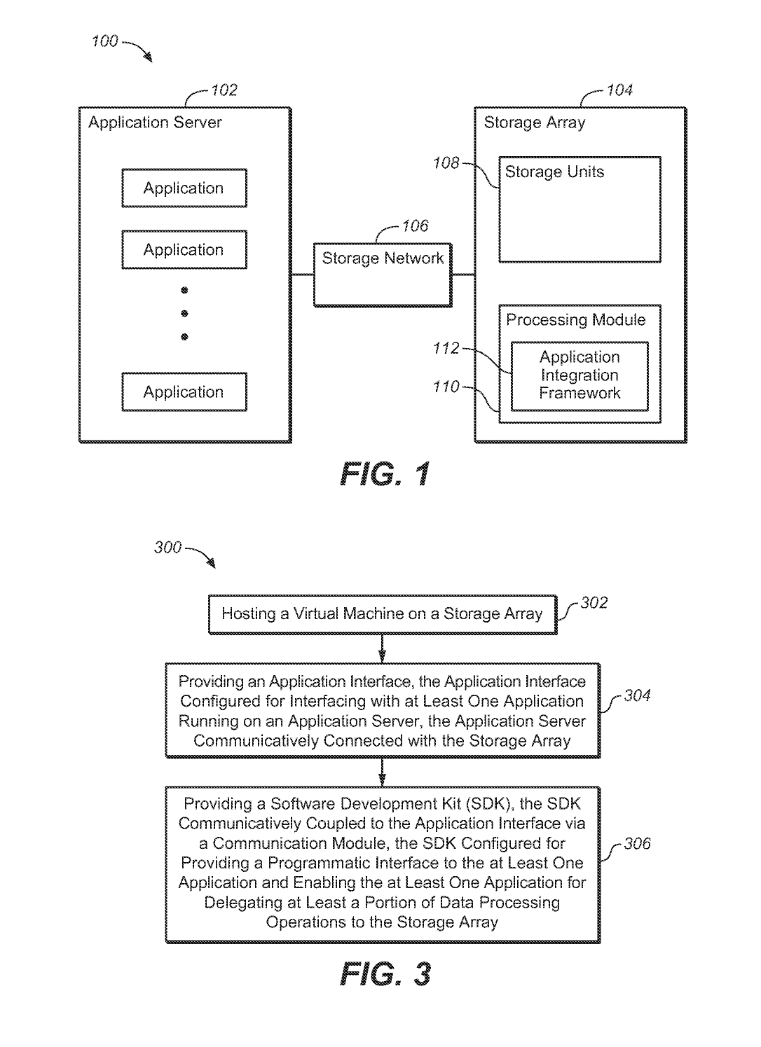

Referring to FIG. 1, a block diagram illustrating a computing system 100 is shown. Various applications running on one or more application server 102 may access the data stored in a storage array 104 via a storage network 106 (e.g., SCSI, iSCSI, FC, SAS or the like). The storage array 104 may include a plurality of storage units 108 (e.g., disk drives or the like) configured for storing data. The storage array 104 may further include a processing module 110 (e.g., a processor or the like) capable of hosting one or more virtual machines (VMs). One of the virtual machines may be configured to host the application integration framework 112.

The application integration framework 112 of the present disclosure may allow an application running on the application server 102 to delegate (e.g., offload or hand over) at least a portion of its data handling functionalities to the storage array 104. For instance, if processing data within the storage array 104 and then providing the processed result to the application server 102 can reduce bandwidth consumptions compared to transferring all necessary data to the application server 102 for processing, then at least a portion of the data processing functionalities may be delegated to the storage array 104. In this manner, the storage array 104 may be utilized not only as a data store/provider, but also as a data processing unit.

In one embodiment, the application integration framework of the present disclosure allows the storage array to expose a programmable interface for data movement operations, array health and configuration information, and specific user operations. The applications running on one or more application servers may therefore utilize such interfaces for data processing purposes. Furthermore, the interfaces provided may also restrict the interactions between the applications and the storage array to only the defined/allowed functionalities.

The application integration framework of the present disclosure allows applications to have a server side component (e.g., a portion of the application running on the application server 102) and a storage array side component (e.g., another portion of the application running on the storage array 104). The server side component may handle resource intensive data processes while the storage array side component may provide certain data accessing/manipulation functionalities that may help reducing network traffic. The storage array side of the application may, for example, read data out of the storage array 104, apply a compression algorithm and/or data encryption algorithm and then transfer the compressed/encrypted data back to the application over the storage network 106.

In one embodiment, the portion of the application running on the storage array side may be executed within the context of a Virtual Machine (VM) on the storage array controller. It is contemplated that such applications may be programmed to run on the particular Operating System (OS) that the VM provides. It is further contemplated that its communications with other VMs (e.g., the storage array may include more than one VM) and/or to the storage array firmware/controller may be abstracted out by the application integration framework.

Functionalities that may be provided by the storage array may include data movement operations. Such operations may read data out from a virtual volume of the storage array and pass it on to another virtual volume of the storage array. By providing data movement operations within the storage array itself, an application no longer need to consume precious bandwidth just for moving data around. Other functionalities that may be provided by the storage array may include policy checking to ensure that user defined policies for the application data is met. For instance, policies that may be applied by the application may include Quality of Service (QoS) policies which may be set by the storage array administrator for specific volumes assigned to an application. Providing such functionalities on the storage array may allow the applications to enforce the application specific policies on data retention, data deduplication, data migration or the like.

It is understood that additional data processing functionalities may be provided by the storage array without departing from the spirit and scope of the present disclosure. For example, the application integration framework may allow read/write block IOs, read file attributes, data compression/decompression, data encryption/decryption, check status/configuration of the underlying disks (including information on whether disk based encryption has been turned on for the volumes which the application has its data on), list what snapshots have been created out of the original volumes and their lifelines and any other information which may be useful for validating and enforcing any protection policies that an application might require on its data. Furthermore, a policy validation engine may be provided which can be completely hosted by the storage array itself and not having any footprint on any of the application servers.

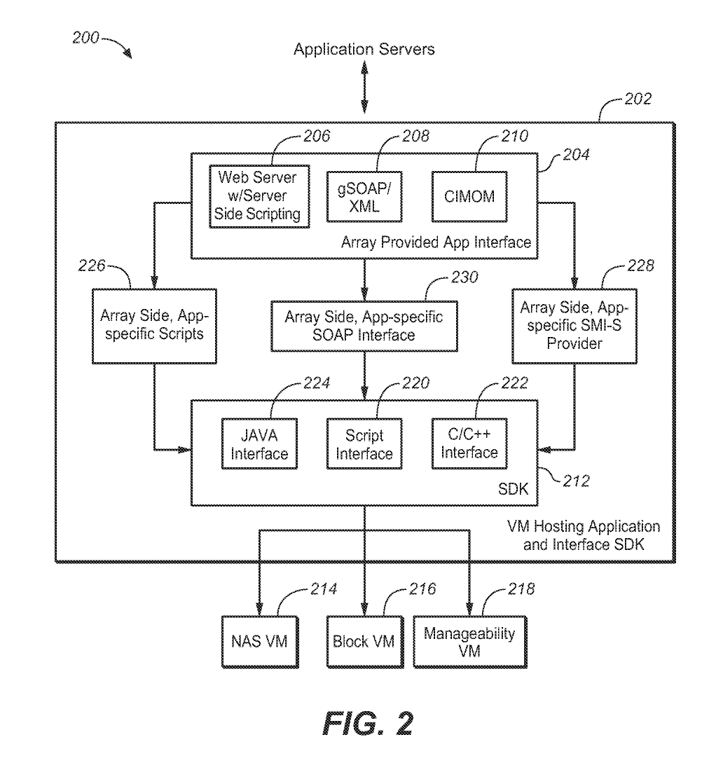

Referring to FIG. 2, a block diagram illustrating an exemplary implementation of the application integration framework 200 for a storage array is shown. In one embodiment, the storage array may host a VM 202 with the necessary integration framework for providing data accessing/manipulation functionalities. The integration framework 200 may include one or more application interfaces 204 configured for interfacing with one or more application servers communicatively connected with the storage array. For example, the application interfaces 204 may include, but not limited to, a web server 206 for handling web based interaction (e.g., via HTTPS connections or the like) with the storage array, a gSOAP/XML server 208 for handling SOAP requests (e.g., C/C++ based SOAP request or the like), and a CIMOM (Common Information Model object manager) server 210 for handling CIM requests. The web server 206 may also be configured for supporting SOAP/XML requests and server side scripts (dynamic contents).

The integration framework 200 further includes a Software Development Kit (SDK) 212 configured for providing a programmatic interface to the applications running on the application server and enabling such applications to delegate at least a portion of data processing operations to be carried out by the storage array. Processes running on the VM 202 may interact with the storage array controller and/or other VMs (e.g., network-attached storage VM 214, block VM 216, manageability VM 218 or the like) of the storage array utilizing the SDK 212. In one embodiment, The SDK 212 is configured to provide a script interface 220 (for applications relying on server side scripting), a C/C++ interface 222 and a Java interface 224.

One or more communication modules may be utilized to facilitate communications between the application interfaces 204 and the SDK 212. For example, if a web based request is received through the web server 206, then the scripts that can be invoked from the web server may be provided to the SDK 212 via a script communication module 226. Similarly, an SMI-S provider 228 may be registered with the CIMOM server 210 to facilitate the communication between the CIMOM server 210 and the SDK 212. Furthermore, SOAP requests received at the gSOAP/XML server 208 may be communicated to the SDK 212 via the (g)SOAP interface 230.

Utilizing the integration framework 200 of the present disclosure, any application that wants to delegate at least a portion of its data access layer to the storage array may do so in any of the format provided by the framework (Java/C/C++/script in the example above); the server side portion of the application (i.e., the portion that is not handled by the storage array) may access its storage array side counterpart via any of the specified application interfaces 204 (e.g., web page requests via HTTPS, SOAP commands, CIM requests). The SDK 212 may manage communications between the VM hosting the integration framework 200 and various other VMs also being hosted by the storage array. In this manner, the SDK may, if needed, maintain state of the calls it receives from the hosted applications; the SDK may also have the intelligence to queue calls and report status asynchronously back to the calling applications.

It is contemplated that the list of application interfaces provided above is merely exemplary. Various other interfaces may be provided without departing from the spirit and scope of the present disclosure. It is also contemplated that, for ease of development, the storage array side of the application may be deployed as a simple script (e.g. a java script) or a native binary. A write-once run-anywhere kind of an application may be appreciated so as to avoid any dependency on the VM operating system on which the framework is deployed.

FIG. 3 shows a flow diagram illustrating steps performed by a method 300 configured for enabling an application to delegate at least a portion of data processing operations to a storage array in accordance with the present disclosure. One or more virtual machines may be hosted on the storage array in step 302. One of the virtual machines may be configured to provide the application integration framework of the present disclosure. For instance, step 304 may provide one or more application interface as previously described. The application interface is being configured for interfacing with at least one application running on the application server. Step 306 may provide the SDK as previously described. In one embodiment, the SDK is communicatively coupled to the application interface via one or more communication modules. The SDK is configured for providing a programmatic interface to the at least one application and enabling the at least one application for delegating at least a portion of data processing operations to the storage array.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A storage array, comprising:
a plurality of storage units configured for providing data storage;
a processing module configured for hosting a virtual machine; and
an application integration framework provided by the virtual machine, the application integration framework further comprising:
an application interface, the application interface configured for interfacing with at least one application running on an application server, the application server communicatively connected with the storage array; and
a software development kit (SDK) communicatively coupled to the application interface via a communication module, the SDK configured for providing a programmatic interface to the at least one application and enabling the at least one application for delegating at least a portion of data processing operations to the storage array.

2. The storage array of claim 1, wherein the at least one application is permitted to delegate data processing operations to the storage array only via the programmatic interface, and the programmatic interface defines a set of permissible data processing operations available to the at least one application.

3. The storage array of claim 2, wherein the set of permissible data processing operations comprises at least one of: a read operation, a write operation, a data movement operation, a data compression operation, a data decompression operation, a data encryption operation, a data decryption operation, a storage array health information request, a storage array configuration information request, a storage array status information request, a policy checking operation, and a user defined operation.

4. The storage array of claim 1, wherein the SDK is further configured for providing communication with at least one of: a storage array controller, and another virtual machine hosted by the processing module.

5. The storage array of claim 1, wherein the SDK comprises at least one of: a script interface, a C/C++ interface, and a Java interface.

6. The storage array of claim 1, wherein the application interface comprises at least one of: a web server, a gSOAP/XML server, and a Common Information Model Object Manager (CIMOM) server.

7. The storage array of claim 6, wherein the communication module comprises at least one of:
a script communication module for communicatively connecting the web server and the SDK;
a gSOAP interface for communicatively connecting the gSOAP/XML server and the SDK; and
an SMI-S provider for communicatively connecting the CIMOM server and the SDK.

8. An application integration framework provided by a virtual machine running on a storage array, the application integration framework comprising:
an application interface, the application interface configured for interfacing with at least one application running on an application server, the application server communicatively connected with the storage array; and
a software development kit (SDK) communicatively coupled to the application interface via a communication module, the SDK configured for providing a programmatic interface to the at least one application and enabling the at least one application for delegating at least a portion of data processing operations to the storage array.

9. The application integration framework of claim 8, wherein the at least one application is permitted to delegate data processing operations to the storage array only via the programmatic interface, and the programmatic interface defines a set of permissible data processing operations available to the at least one application.

10. The application integration framework of claim 9, wherein the set of permissible data processing operations comprises at least one of: a read operation, a write operation, a data movement operation, a data compression operation, a data decompression operation, a data encryption operation, a data decryption operation, a storage array health information request, a storage array configuration information request, a storage array status information request, a policy checking operation, and a user defined operation.

11. The application integration framework of claim 8, wherein the SDK is further configured for providing communication with at least one of: a storage array controller, and another virtual machine running on the storage array.

12. The application integration framework of claim 8, wherein the SDK comprises at least one of: a script interface, a C/C++ interface, and a Java interface.

13. The application integration framework of claim 8, wherein the application interface comprises at least one of: a web server, a gSOAP/XML server, and a Common Information Model Object Manager (CIMOM) server.

14. The application integration framework of claim 13, wherein the communication module comprises at least one of:
a script communication module for communicatively connecting the web server and the SDK;
a gSOAP interface for communicatively connecting the gSOAP/XML server and the SDK; and
an SMI-S provider for communicatively connecting the CIMOM server and the SDK.

15. A method, comprising:
hosting a virtual machine on a storage array;
providing an application interface, the application interface configured for interfacing with at least one application running on an application server, the application server communicatively connected with the storage array; and
providing a software development kit (SDK), the SDK communicatively coupled to the application interface via a communication module, the SDK configured for providing a programmatic interface to the at least one application and enabling the at least one application for delegating at least a portion of data processing operations to the storage array;
wherein the application interface, the SDK and the communication module are being provided by the virtual machine hosted on the storage array.

16. The method of claim 15, wherein the at least one application is permitted to delegate data processing operations to the storage array only via the programmatic interface, and the programmatic interface defines a set of permissible data processing operations available to the at least one application.

17. The method of claim 16, wherein the set of permissible data processing operations comprises at least one of: a read operation, a write operation, a data movement operation, a data compression operation, a data decompression operation, a data encryption operation, a data decryption operation, a storage array health information request, a storage array configuration information request, a storage array status information request, a policy checking operation, and a user defined operation.

18. The method of claim 15, wherein the SDK comprises at least one of: a script interface, a C/C++ interface, and a Java interface.

19. The method of claim 15, wherein the application interface comprises at least one of: a web server, a gSOAP/XML server, and a Common Information Model Object Manager (CIMOM) server.

20. The method of claim 19, wherein the communication module comprises at least one of:
a script communication module for communicatively connecting the web server and the SDK;
a gSOAP interface for communicatively connecting the gSOAP/XML server and the SDK; and
an SMI-S provider for communicatively connecting the CIMOM server and the SDK.
